(19) United States
(12) Patent Application Publication
(10) Pub. No.: US 2020/0250757 A1
(43) Pub. Date: Aug. 6, 2020

(54) Method for Digital Interface with User Feedback to Ease User Interactions with Securities Trading

(71) Applicant: Gatsby Digital, Inc., Wilton, CT (US)

(72) Inventors: Ryan Belanger-Saleh, Wilton, CT (US); Davis Gaynes, Rye, NY (US); Jeffrey Myers, Fairfield, CT (US); Alexander Wohl, Purchase, NY (US)

(73) Assignee: Gatsby Digital, Inc., Wilton, CT (US)

(21) Appl. No.: 16/265,831

(22) Filed: Feb. 1, 2019

(51) Int. Cl. G06Q 40/06; G06F 3/0481

(52) U.S. Cl. CPC G06Q 40/06; G06F 3/04817

(57) ABSTRACT

The present invention concerns methods of providing feedback to a user based on the amount of risk underlying an options contract. The invention uses a display screen, with a selection mechanism, to allow the user to interface directly the with parameters of a potential options, while providing feedback, typically in the form of color changes, vibration, or sounds, to the user while the risk of the options contract increases. Evaluating the underlying risk of an options contract is a difficult process for the individual investor who lacks the advanced mathematical models of institutional investors. The present invention consolidates the factors into a simplified tool that analyzes the factors and communicates risk to the user through the feedback mechanisms.

### BACKGROUND

### Field of the Invention

The present invention relates generally to methods of displaying a digital interface on a screen. More specifically, the present invention relates to a method for easing user interactions with a digital interface when performing securities transactions.

### Description of the Related Art

In the field of securities transactions, when an investor is purchasing an options contract, two key pieces of information are required for the transaction; strike price and expiration date. Strike price is the fixed price at which an option can be exercised, and the expiration date of an options contract is the last day an owner may exercise his option.

There is significant risk with any chosen strike price or expiration date. The risk associated with an options contract factors into how valuable a contract will be, as a high-risk contract is less likely to be actionable, but may have a higher return on investment. A low-risk contract is more likely to be actionable, but typically has a lower return on investment. Market volatility, historical trends, and numerous other factors play into how valuable a contract will be. As such, an investor needs to have a deep understanding of all the factors associated with the options contract, and associated with the market, to be able to make intelligent investments.

Guidance is currently available for investors on how to make intelligent investments, but these are either matrices for each individual factor that could impact the outcome or direction of an underlier or other security or require reviewing evaluative formulas for those same factors. This complexity is largely outside of the scope of understanding for an individual investor, such as an everyday individual not working heavily in this field. Individual investors are limited to systems by which they need to have their own understanding of the level of risk or likelihood of success for any given factor contributing to the securities-related transaction, and then must either enter these variables manually or select them from a set of static values. This puts the individual investor at a significant disadvantage compared to the institutional traders with advanced mathematical tools to guide their investments.

### SUMMARY

In accordance with the embodiments herein, a method for providing feedback to a user through a digital interface based on the risk associated with an options transaction. The method described herein generally involves displaying to a user a dynamic selection mechanism for an options transaction; providing feedback to the user through interaction with the dynamic selection mechanism; increasing the feedback to the user as the risk for the options transaction increases; and providing a mechanism for the user to perform the options transaction.

### BRIEF DESCRIPTION OF THE DRAWINGS

FIG. 1 shows an overview of the method.

FIG. 2 shows the haptic feedback provided by the method as risk increases.

FIG. 3 shows the auditory feedback provided by the method as risk increases.

### DETAILED DESCRIPTION OF EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention.

When making decisions to trade options contracts, properly evaluating the riskiness of such options contract involves quantifying numerous factors such as expiration date, underlying security price, volatility of the underlying security (usually measured in standard deviation of its mean logarithmic return), and many other factors. Such a process is difficult for the individual investor who lacks the mathematical models of institutional investors. The present invention consolidates these factors into a simplified tool that analyzes the factors and communicates risk to the user through feedback methods.

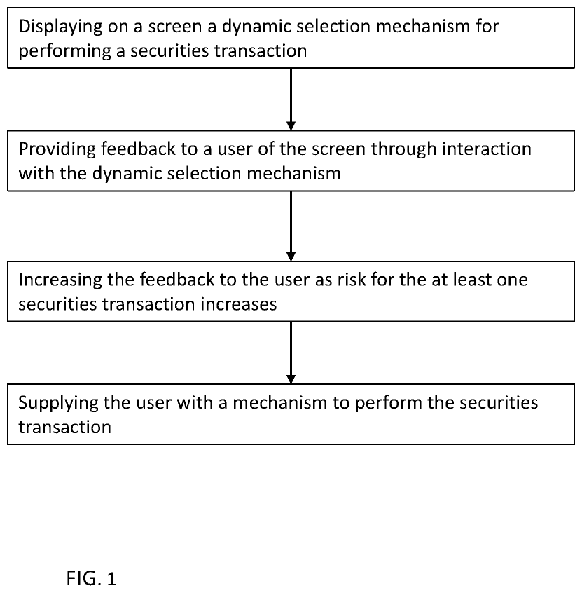

In an illustrative embodiment of the invention, as summarized in FIG. 1, the method may be summarized of the following four steps: i) displaying on a screen a dynamic selection mechanism for an options transaction; ii) providing feedback to a user through interaction with the dynamic selection mechanism; iii) increasing the feedback to the user as risk for the options transaction increases; and iv) supplying the user with a purchase mechanism to perform the options transaction. Preferably the present invention is used for the purchasing and selling of options contracts, but other securities transactions are contemplated.

In the above embodiment, the screen could be a computer monitor, a laptop screen, the screen of a tablet, or attached to a mobile device such as a smartphone. Other screens are contemplated within the scope of the present invention, and one of ordinary skill in the art would recognize other screens applicable to the present invention.

In other embodiments, the dynamic selection mechanism could be a scroll wheel, a slider bar, a number selection, or other ways of selecting or inputting a numerical value through a digital interface. Any number of viable selection mechanisms could be used with the present invention, in a vertical, horizontal, grid-based, angular, or value entry modalities.

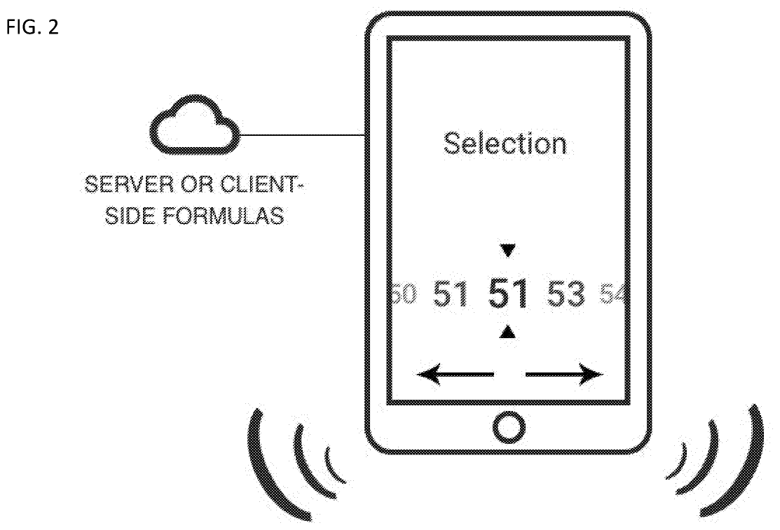

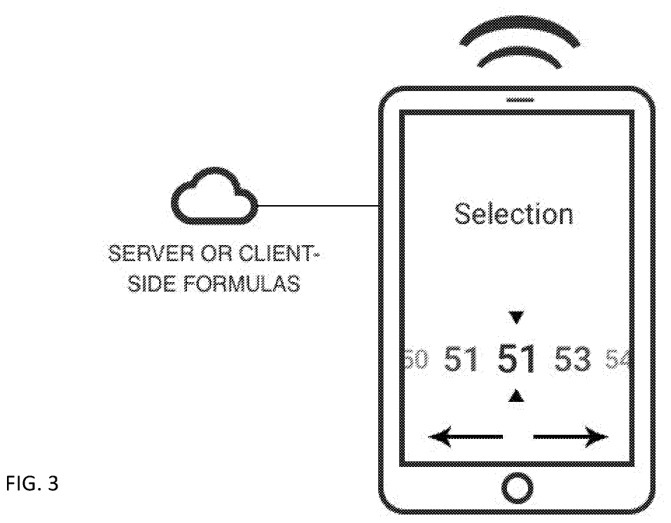

In further embodiments, the feedback provided to the user of the present invention could be visual feedback, haptic feedback, as seen in FIG. 2, or auditory feedback, as seen in FIG. 3. The combination of these different types of feedback is also used in some embodiments. Visual feedback provided could be in the form of color changes, such as increasing the “redness” of the selection mechanism as risk increases, or in the form of “resistance” the changes in the selection mechanism, by slowing down scrolling on a slider or scroll wheel or requiring multiple presses for numerical selection for example. Haptic feedback could be in the form of vibration or other forms of haptic feedback as appropriate to the device upon which the embodiment is implemented. Auditory feedback could be in the form of beep, chirp, whirr, chime, ding, klaxon, or other auditory notification. Additionally, the auditory feedback could be selected by the user in a configuration setting for the present invention.

As risk increases, the feedback provided to the user would also increase. For example, a selection wheel could scroll more slowly and gain more red color (such as going from green to yellow to red) as the risk increases. Additionally, auditory feedback could become louder or haptic feedback could be provided with longer or stronger vibration as the risk increases. These feedback systems could be used individually or together for more feedback to the user. It is contemplated that the feedback systems could be used sequentially, as well. An example of this concept is that a slider bar could become red at a certain level of risk, and higher risk could then have vibration feedback after that. Finally, at even higher levels of risk, a loud auditory chime may occur when risk is pushed much higher.

Further embodiments include multiple ways to calculate the risk associated with the selected transaction. Expiry date, strike price, the volatility of the security underlying the option, or the combination of some or all of these factors could be used to calculate the risk associated with the selected transaction. This risk could be calculated locally where the present invention is being performed or remotely via a server-side calculation or other remote calculation.

1. A method for providing feedback to a user through a digital interface comprising:
displaying on a screen of a mobile computing device a dynamic selection mechanism for at least one options transaction;
providing feedback to a user through interaction with the dynamic selection mechanism;
increasing the feedback to the user as risk for the at least one options transaction increases; and
supplying the user with a purchase mechanism to perform the options transaction;
wherein the dynamic selection mechanism is a horizontal slider bar; and
wherein the feedback to the user is increasing resistance to sliding along the horizontal slider bar as risk increases, color changes to the horizontal slider bar from white to yellow to red as risk increases, and vibration of increasing intensity as risk increases.

2. (canceled)

3. The method of claim 2, wherein the mobile computing device is a mobile phone.

4. The method of claim 2, wherein the mobile computing device is a tablet computer.

5. (canceled)

6. (canceled)

7. (canceled)

8. (canceled)

9. (canceled)

10. (canceled)

11. (canceled)

12. (canceled)

13. The method of claim 17, wherein the auditory feedback is selected by the users as part of a configuration.

14. The method of claim 1, wherein the risk is calculated based on expiration date.

15. The method of claim 1, wherein the risk is calculated based on strike price.

16. The method of claim 1, wherein the risk is calculated based on the combination of expiration date and strike price.

17. The method of claim 1, further comprising auditory feedback selected from the group consisting of beep, chirp, whirr, chime, ding, and klaxon sounds.
